(19) United States
(12) Patent Application Publication
(10) Pub. No.: US 2026/0031708 A1
(43) Pub. Date: Jan. 29, 2026

(54) SYNCHRONOUS RECTIFIER FOR USE IN A WIRELESS POWER TRANSFER SYSTEM

(71) Applicant: Solace Power Inc., Mount Pearl (CA)

(72) Inventors: Dominic JEYAMANOHARAN, St. John's (CA); Rasool KAHANI, St. John's (CA); Anthony PENNEY, Grand Falls-Windsor (CA)

(73) Assignee: Solace Power Inc., Mount Pearl (CA)

(21) Appl. No.: 19/280,530

(22) Filed: Jul. 25, 2025

Related U.S. Application Data
(60) Provisional application No. 63/675,820, filed on Jul. 26, 2024.

(51) Int. Cl. H02M 1/088; H02J 50/12; H02M 7/217

(52) U.S. Cl. CPC H02M 1/088; H02J 50/12; H02M 7/217

(57) ABSTRACT

A trigger circuit for use in a rectifier of a receiver of a wireless power transfer system is provided. The rectifier is for receiving wireless power transferred from a transmitter of the wireless power transfer system. The trigger circuit comprises a differential comparator for generating a trigger signal by comparing a positive input signal received at a receive element of the receiver to a negative input signal received at the receive element.

### CROSS-REFERENCE TO RELATED APPLICATIONS

This application claims the benefit of U.S. Provisional Application No. 63/675,820 filed on Jul. 26, 2024, the entire contents of which is incorporated herein by reference.

### TECHNICAL FIELD

The subject disclosure relates generally to wireless power transfer, and in particular, to a synchronous rectifier for use in a wireless power transfer system and to a method for synchronous rectification in wireless power transfer.

### BACKGROUND

Wireless charging and wireless power transfer systems are becoming an increasingly important technology to enable the next generation of devices. The potential benefits and advantages offered by the technology is evident by the increasing number of manufacturers and companies investing in the technology.

A variety of wireless power transfer systems are known. A typical wireless power transfer system includes a wireless power transmitter comprising a power source electrically connected to a transmit element, and a wireless power receiver comprising a receive element electrically connected to a load.

For example, in magnetic induction systems, the transmit element comprises an induction coil that transfers electrical energy from the power source to an induction coil of the receive element. The transferred electrical energy is then applied to the load. Power transfer occurs due to coupling of magnetic fields between the induction coils of the transmit and receive elements. The range of these magnetic induction systems is however, limited and the induction coils of the transmit and receive elements must be in optimal alignment for power transfer. Resonant magnetic systems, which transfer power due to coupling of magnetic fields between the induction coils of the transmit and receive elements also exist. In these resonant magnetic systems, the induction coils of the transmit and receive elements are resonated using high quality factor (high Q) capacitors. The range of power transfer in resonant magnetic systems is increased over that of magnetic induction systems and alignment issues are rectified. While electromagnetic energy is produced in magnetic induction and resonant magnetic systems, the majority of power transfer occurs via the magnetic field. Little, if any, power is transferred via electric induction or resonant electric induction.

Another example of wireless power systems is electric field coupling systems in which the transmit and receive elements have capacitive electrodes and power transfer occurs due to coupling of electric fields between the capacitive electrodes of the transmit and receive elements. Resonant electric field systems also exist in which the capacitive electrodes of the transmit and receive elements are made resonant using high quality factor (high Q) inductors. Similar to resonant magnetic systems, resonant electric field systems have an increased range of power transfer compared to that of non-resonant electric field systems and alignment issues are rectified. While electromagnetic energy is produced in electric induction and resonant electric systems, the majority of power transfer occurs via the electric field. Little, if any, power is transferred via magnetic induction or resonant magnetic induction.

Other exemplary wireless power systems may use radio frequency (RF) waves to transmit power. Controlled constructive interference of the RF waves forms energy at the receiver to transfer power wirelessly.

While wireless power transfer systems, transmitters, receivers, and methods are known, improvements are desired.

This background serves only to set a scene to allow a person skilled in the art to better appreciate the following description. Therefore, none of the above discussion should necessarily be taken as an acknowledgement that that discussion is part of the state of the art or is common general knowledge. One or more aspects/embodiments of the disclosure may or may not address one or more of the background issues.

### SUMMARY

According to an aspect of the disclosure there is provided a trigger circuit for use in a rectifier of a receiver of a wireless power transfer system. The trigger circuit may result in a rectifier with improved performance (e.g., improved efficiency, more stable performance, more accurate switching, and/or reduced delay), smaller form factor, and/or reduced cost than conventional rectifiers. The rectifier may be a synchronous rectifier. The synchronous rectifier may synchronize the switching points in the rectifier with a waveform of a received sinusoidal RF power signal.

The trigger circuit may comprise:
a differential comparator for generating a trigger signal by comparing a positive input signal received at a receive element of the receiver to a negative input signal received at the receive element.

For the purposes of the subject disclosure the term differential comparator is defined as a comparator which compares at least two input signals to each other, rather than comparing a signal to ground. As such, the differential comparator determines the differences between the at least two input signals, rather than a difference between an input signal and ground.

The positive input signal and the negative input signal may be out of phase. The positive input signal and the negative input signal may be approximately 180 degrees out of phase.

The input signals may comprise sines waves. The sine waves may be out of phase. The sine waves may be approximately 180 degrees out of phase.

The differential comparator may have a duty cycle of 50%. An output of the differential rectifier may have a duty cycle of 50%.

The trigger circuit may further comprise a filter for filtering at least one of the input signals. The filter may filter or clean the inputs signals. The output of the filter may be clean sine waves which are input into the differential comparator.

The filter may comprise at least two tank circuits. The tank circuit may filter the input signals. Specifically, each tank circuit may filter one of the input signals. Each tank circuit may comprise an inductor and capacitor electrically connected together.

The trigger circuit may comprise at least one sampling circuit for sampling the positive or negative input signal.

The sampling circuit comprises at least one divider circuit. One divider circuit may be electrically connected to one end of the receive element (e.g., positive terminal). Another divider circuit may be electrically connected to another end of the receive element (e.g., negative terminal).

The trigger circuit may be electrically connectable to gate drivers. The trigger circuit may be electrically connectable to two gate drivers. The gate drivers may form part of the rectifier. The gate drivers may be adapted to output a gate signal for controlling rectifying element (e.g., FETs). The gate drivers may receive the trigger signal output by the trigger circuit and produce gate signals, each gate signal for controlling respective rectifying element (e.g., FETs) of the rectifier.

The trigger circuit may be configured to output the trigger signal to operate a gate driver of a rectifier. The trigger signal may comprise a pulse signal.

The trigger signal may comprise a clock signal.

The trigger signal may comprise a square wave.

The trigger circuit may be electrically connectable to a receive element of the receiver.

The trigger circuit may be powered by an auxiliary power source. The auxiliary power source may receive a rectified voltage from a rectifying element of the rectifier for powering the trigger circuit. The auxiliary power source may comprise an auxiliary direct current/direct current (DC/DC) converter. The auxiliary DC/DC converter may convert a rectified voltage output by a rectifying element of the rectifier to a suitable voltage for powering the trigger circuit.

According to another aspect there is provided a rectifier for use in a receiver of a wireless power transfer system, the rectifier for receiving wireless power transferred from a transmitter of the wireless power transfer system. The rectifier may have one or more of the benefits, features, and/or elements described in connection with the trigger circuit.

The rectifier may comprise:
two rectifier elements for rectifying an input AC signal received at a receive element of the receiver to DC;
two gate drivers, each gate driver for controlling operation of one of the two rectifier elements; and
a trigger circuit comprising a differential comparator for generating trigger signals for operating the gate drivers by comparing a positive input signal received at the receive element to a negative input signal received at the receive element.

The positive input signal and the negative input signal may be out of phase. The positive input signal and the negative input signal may be approximately 180 degrees out of phase.

The input signals may comprise sines waves. The sine waves may be out of phase. The sine waves may be approximately 180 degrees out of phase.

The differential comparator may have a duty cycle of 50%. An output of the differential rectifier may have a duty cycle of 50%.

The trigger circuit may further comprise a filter for filtering at least one of the input signals. The filter may filter or clean the inputs signals. The output of the filter may be clean sine waves which are input into the differential comparator.

The filter may comprise one or more tank circuits and/or high pass filters. The tank circuit may filter the input signals. Specifically, each tank circuit may filter one of the input signals. Each tank circuit may comprise an inductor and capacitor electrically connected together.

The trigger circuit may further comprise at least one sampling circuit. The trigger circuit may further comprise two sampling circuits. Each sampling circuit may be for sampling a respective one of the positive and negative input signals.

The sampling circuit may comprise at least one divider circuit. One divider circuit may be electrically connected to one end of the receive element (e.g., positive terminal). Another divider circuit may be electrically connected to another end of the receive element (e.g., negative terminal).

The trigger circuit may be electrically connectable to gate drivers. The trigger circuit may be electrically connectable to two gate drivers. The gate drivers may form part of the rectifier. The gate drivers may be adapted to output a gate signal for controlling rectifying element (e.g., FETs). The gate drivers may receive the trigger signal output by the trigger circuit and produce gate signals, each gate signal for controlling respective rectifying element (e.g., FETs) of the rectifier.

The trigger circuit may be configured to output the trigger signal to operate a gate driver of a rectifier. The trigger signal may comprise a pulse signal.

The trigger signal may comprise a clock signal.

The trigger signal may comprise a square wave.

The trigger circuit may be electrically connectable to a receive element of the receiver. The trigger circuit may be electrically connected to a receive element of the receiver via one or more other electrical circuits as will be described. The trigger circuit may be indirectly electrically connected to the receive element.

The trigger circuit may be powered by an auxiliary power source. The auxiliary power source may receive a rectified voltage from a rectifying element of the rectifier for powering the trigger circuit. The auxiliary power source may comprise an auxiliary DC/DC converter. The auxiliary DC/DC converter may convert a rectified voltage output by a rectifying element of the rectifier to a suitable voltage for powering the trigger circuit.

Each filter may be electrically connected to each sampling circuit between the sampling circuit and the differential comparator.

The rectifier may further comprise a filter electrically connected to at least one rectifier element. The rectifier may further comprise two filters, each filter electrically connected to a rectifier element. Each filter may comprise a series LC filter. The series LC filter may comprise an inductor electrically connected to a capacitor in series.

The rectifier may be load-independent.

According to another aspect there is provided a receiver for extracting power from a transmitter of a wireless power transfer system. The receiver may have one or more of the benefits, features, and/or elements described in connection with the trigger circuit and/or rectifier.

The receiver may comprise
a receive element for receiving wireless power transferred from the transmitter; and
a rectifier for use in a receiver of a wireless power transfer system, the rectifier for receiving wireless power transferred from a transmitter of the wireless power transfer system, the rectifier comprising:
   two rectifier elements for rectifying an input AC signal received at a receive element of the receiver to DC;
   two gate drivers, each gate driver for controlling operation of one of the two rectifier elements; and
   a trigger circuit comprising a differential comparator for generating trigger signals for operating the gate drivers by comparing a positive input signal received at the receive element to a negative input signal received at the receive element.

The receive element may be for extracting power via electric or magnetic field coupling.

the receive element may be for extracting power via resonant and/or non-resonant electric or magnetic field coupling.

An input signal received at the receive element may be an alternating current (AC) signal.

The receiver may further comprise: a load electrically connected to the rectifier.

According to another aspect there is provided a wireless power transfer system for transmitting power via magnetic or electric field coupling. The system may have one or more of the benefits, features, and/or elements described in connection with the trigger circuit, rectifier, and/or receiver.

The system may comprise:
a transmitter comprising a transmit element for generating a magnetic or electric field;
a receiver for extracting power from the transmitter, the receiver comprising:
a receive element for receiving wireless power transferred from the transmitter; and
a rectifier for use in a receiver of a wireless power transfer system, the rectifier for receiving wireless power transferred from a transmitter of the wireless power transfer system, the rectifier comprising:
   two rectifier elements for rectifying an input AC signal received at a receive element of the receiver to DC;
   two gate drivers, each gate driver for controlling operation of one of the two rectifier elements; and
   a trigger circuit comprising a differential comparator for generating trigger signals for operating the gate drivers by comparing a positive input signal received at the receive element to a negative input signal received at the receive element.

The wireless power transfer system may further comprise: a power source electrically connected to the transmitter.

The wireless power transfer system may further comprise: a load electrically connected to the rectifier.

According to another aspect there is provided a method of operating a gate driver of a rectifier of a receiver of a wireless power transfer system. The receiver may comprise a receive element for extracting power from a generated field. The rectifier may comprise one or more gate drivers. The method may have one or more of the benefits, features, and/or elements described in connection with the trigger circuit, rectifier, receiver, and/or system.

The method may comprise:
comparing a positive input signal received at the receive element to a negative input signal received at the receive element to generate a trigger signal; and
operating the gate driver via the generated trigger signal.

The comparing may be performed via a differential comparator. The differential comparator may form a portion of a trigger circuit, such as the described trigger circuit.

Operating the gate driver may comprise outputting a gate signal from the gate driver to control a rectifying element of a rectifier.

The method may further comprise filtering the positive and/or negative input signal.

The filtering may occur prior to the comparing. In other words, one or more of input signals may be filtered prior to being compared to the other input signal.

Filtering may comprise filtering the positive and/or negative input signal via one or more tank circuits and/or high pass filters. The tank circuit may form a portion of a trigger circuit.

The method may further comprise sampling the positive and/or negative input signal. One or more of the input signals may be sampled at an output of a receiver element of the receiver. The positive input signal may be sampled at one end of the receiver element, while negative input signal may be sampled at another end of the receiver element.

According to another aspect there is provided a method of rectifying an input signal received at a receive element of a receiver of a wireless power transfer system. The method may have one or more of the benefits, features, and/or elements described in connection with the trigger circuit, rectifier, receiver, system, and/or method of operating a gate driver. The receive element may be for extracting power from a generated field. The receiver may further comprise a rectifier comprising one or more gate drivers controlling operation of one or more rectifier elements.

The method may further comprise:
comparing a positive input signal received at the receive element to a negative input signal received at the receive element to generate a trigger signal;
operating the gate driver via the generated trigger signal to generate a gate signal; and
driving the rectifier elements via the generated gate signal.

The comparing may be performed via a differential comparator. The differential comparator may form a portion of a trigger circuit, such as the described trigger circuit.

Operating the gate driver may comprise outputting a gate signal from the gate driver to control a rectifying element of a rectifier.

The method may further comprise filtering the positive and/or negative input signal.

The filtering may occur prior to the comparing. In other words, one or more of input signals may be filtered prior to being compared to the other input signal.

Filtering may comprise filtering the positive and/or negative input signal via one or more tank circuits and/or high pass filters. The tank circuit may form a portion of a trigger circuit.

The method may further comprise sampling the positive and/or negative input signal. One or more of the input signals may be sampled at an output of a receiver element of the receiver. The positive input signal may be sampled at one end of the receiver element, while negative input signal may be sampled at another end of the receiver element.

According to another aspect there is provided a method of receiving wireless power. The method may have one or more of the benefits, features, and/or elements described in connection with the trigger circuit, rectifier, receiver, system, method of operating a gate driver, and/or method of rectifying an input signal received at a receive element of a receiver of a wireless power transfer system.

The method may comprise extracting power from a magnetic or electric field generated by a transmit element of a transmitter of the wireless power transfer system by a receive element of a receiver of the wireless power transfer system; and rectifying the extracted power with two field effect transistors (FET), each FET controlled via a gate signal generated a respective gate driver, the gate driver operated via a trigger signal generated by comparing a positive input signal received at the receive element to a negative input signal received at the receive element.

It should be understood that any features described in relation to one aspect, example or embodiment of the disclosure may also be used in relation to any other aspect or embodiment of the disclosure.

Other advantages of the present disclosure will become apparent to one of skill in the art from the detailed description in association with the following drawings.

### BRIEF DESCRIPTION OF THE FIGURES

A description is now given, by way of example only, with reference to the accompanying drawings, in which:

FIG. 1 is a block diagram of a receiver of a wireless power transfer system;

FIG. 2 is a block diagram of a rectifier for use in a wireless power transfer system;

FIG. 3 is a partial schematic diagram of a receiver of a wireless power transfer system;

FIG. 4 is a partial schematic diagram of a receiver of a wireless power transfer system according to an aspect of the disclosure;

FIG. 5a is a graph of an input signal voltage and output voltage of a differential comparator of a rectifier of a receiver over time;

FIG. 5b is a graph of switching waveforms output by rectifier elements of a rectifier of a receiver over time;

FIGS. 6a-6e are graphs of rectified voltage of a receiver and power transfer efficiency between a transmitter and receiver for various separation distances;

FIG. 7a is a graph of rectified voltages output by rectifiers, and power transfer efficiency of the various receivers over a range of separation distances;

FIG. 7b is a graph of rectified voltage differences of various receivers of a range of separation distances;

FIG. 8a is a graph of power transfer efficiency for a variety of media between a receiver and transmitter of a wireless power transfer system;

FIG. 8b is a graph of power transfer efficiency for various receivers;

FIG. 9 is a graph of power transfer efficiency and thermal performance over time; and

FIG. 10 is a flowchart of a method of rectifying power received at a receiver of a wireless power transfer system.

### DESCRIPTION OF SPECIFIC EMBODIMENTS

The foregoing summary, as well as the following detailed description of certain embodiments will be better understood when read in conjunction with the accompanying drawings. As will be appreciated, like reference characters are used to refer to like elements throughout the description and drawings. As used herein, an element or feature recited in the singular and preceded by the word “a” or “an” should be understood as not necessarily excluding a plural of the elements or features. Further, references to “one example” or “one embodiment” are not intended to be interpreted as excluding the existence of additional examples or embodiments that also incorporate the recited elements or features of that one example or one embodiment. Moreover, unless explicitly stated to the contrary, examples or embodiments “comprising”, “having” or “including” an element or feature or a plurality of elements or features having a particular property might further include additional elements or features not having that particular property. Also, it will be appreciated that the terms “comprises”, “has” and “includes” mean “including but not limited to” and the terms “comprising”, “having” and “including” have equivalent meanings.

As used herein, the term “and/or” can include any and all combinations of one or more of the associated listed elements or features.

It will be understood that when an element or feature is referred to as being “on”, “attached” to, “connected” to, “coupled” with, “contacting”, etc. another element or feature, that element or feature can be directly on, attached to, connected to, coupled with or contacting the other element or feature or intervening elements may also be present. In contrast, when an element or feature is referred to as being, for example, “directly on”, “directly attached” to, “directly connected” to, “directly coupled” with or “directly contacting” another element of feature, there are no intervening elements or features present.

It will be understood that spatially relative terms, such as “under”, “below”, “lower”, “over”, “above”, “upper”, “front”, “back” and the like, may be used herein for ease of describing the relationship of an element or feature to another element or feature as depicted in the figures. The spatially relative terms can, however, encompass different orientations in use or operation in addition to the orientation depicted in the figures.

Reference herein to “example” means that one or more feature, structure, element, component, characteristic and/or operational step described in connection with the example is included in at least one embodiment and or implementation of the subject matter according to the present disclosure. Thus, the phrases “an example,” “another example,” and similar language throughout the present disclosure may, but do not necessarily, refer to the same example. Further, the subject matter characterizing any one example may, but does not necessarily, include the subject matter characterizing any other example.

Reference herein to “configured” denotes an actual state of configuration that fundamentally ties the element or feature to the physical characteristics of the element or feature preceding the phrase “configured to”.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the terms “approximately” and “about” represent an amount close to the stated amount that still performs the desired function or achieves the desired result. For example, the terms “approximately” and “about” may refer to an amount that is within less than 10% of, within less than 5% of, within less than 1% of, within less than 0.1% of, or within less than 0.01% of the stated amount.

Use of the word “exemplary”, unless otherwise stated, means ‘by way of example’ or ‘one example of’, and does not mean a preferred or optimal design, configuration, or implementation.

A wireless power transfer system generally comprises a transmitter comprising a power source electrically connected to a transmit element, and a receiver comprising a receive element electrically connected to a load. Power is transferred from the power source to the transmit element. In certain wireless power transfer modalities power is then transferred from the transmit element to the receive element via resonant or non-resonant electric or magnetic field coupling. The power is then transferred from the receive element to the load.

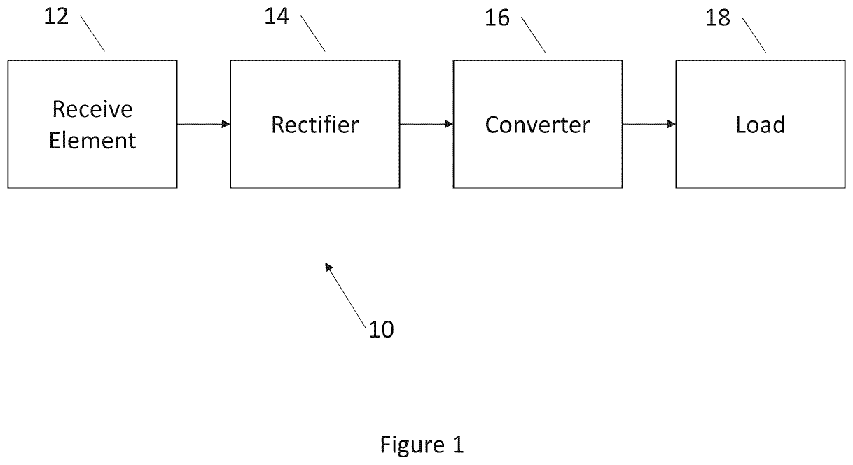

Turning to FIG. 1, an exemplary receiver 10 of such a wireless power transfer system is illustrated. The receiver 10 comprises a receive element 12, a rectifier 14, a converter 16 and a load 18. The receive element 12 is electrically connected to the rectifier 14. The receive element 12 is configured to receive power from a transmitter, e.g. transmitter 10, using resonant or non-resonant electric or magnetic field coupling. The receive element 22 may extract power from a transmitter via non-resonant or resonant magnetic or electric field coupling. As such, the receive element 12 comprises one or more receive coils (i.e. inductors) or one or more capacitive electrodes. The corresponding transmitter comprises corresponding transmit coils (i.e. inductors) or capacitive electrodes, respectively.

The rectifier 14 is electrically connected to the receive element 12. The rectifier 14 is electrically connected to the converter 16. The rectifier 14 is an alternating current (AC)/direct current (DC) rectifier. Generally, the rectifier 14 is for rectifying AC received at the receive element 12 to DC. Specifically, the rectifier 14 is for converting a sinusoidal radio frequency (RF) power signal from the receive element 12 to a DC power signal. The rectifier 14 is configured to output the DC power signal to the converter 16.

The converter 16 is electrically connected to the rectifier 14. The converter 16 is electrically connected to the load 18. The converter 16 is a DC/DC converter. The DC power signal is output from the rectifier 14 to the converter 16. The converter 16 interfaces the rectifier 14 to the load 18. The converter 16 is for converting the received DC voltage signal to a desired voltage level. The converted DC power signal is output from the converter 16 to the load 18.

The load 18 is electrically connected to the converter 16. The load 18 may be a fixed or a variable load.

While the receiver 10 has been described as comprising the converter 16, one of skill in the art will appreciate that other configurations are possible. In another embodiment, the receiver 10 does not comprise the converter 16. In this embodiment, the rectifier 14 is electrically connected to the load 18. The rectifier 14 is configured to generate a DC power signal that is acceptable to the load 18.

As previously stated, the rectifier 14 is for converting sinusoidal RF power signal from the receive element 12 to a DC power signal. The operation of the rectifier 14 may not be synchronized with the sinusoidal RF power signal. As such, there may be a need to synchronize the switching points in the rectifier 14 with the waveform of the received sinusoidal RF power signal. Unsynchronized switching points may result in loss of received power which may reduce power transfer efficiency and provide insufficient power to the load 18.

The rectifier 14 may comprise at least one diode for rectifying AC to DC. Generally, the diode is positioned between an AC source and a load configured to operate using DC. A diode operates like a valve for electric current by allowing the flow of current in one direction and opposing the flow of current in the other direction. Thus, while the AC is flowing in a first direction, the diode operates like a closed switch (i.e. forward biased) allowing current through to the load 18. When AC is flowing in a second direction opposite the first direction, the diodes operates like an open switch (i.e. reverse biased) preventing current through to the load 18. Therefore, unidirectional current flows through to the load 18 without a change in polarity.

Diodes are generally lossy electrical components in that they consume a significant amount of the electrical power they rectify. For example, if a diode has a forward threshold of 0.7 V, it consumes about 0.7 V to be forward biased. There is therefore a 0.7 V voltage drop across the diode when a current flows through the diode.

To at least partially reduce the lossy effects of diodes at the rectifier 14, a rectifier 14 may alternatively comprise a transistor, for example, a field-effect transistor (FET). The gate of the FET is biased by a separate power source. The current between the source and drain of the FET is controlled by the voltage at the gate.

As previously stated, there may be a need to synchronize the switching points in the rectifier 14 with the waveform of the received sinusoidal RF power signal. For example, synchronized switching points may increase power transfer efficiency and may ensure sufficient power is provided to the load 18 and/or converter 16.

Broadly speaking, the FET of a rectifier may comprise a source terminal electrically connected to ground; and a drain terminal electrically connected to a receive element of a receiver of a wireless power transfer system. The receive element is for extracting power from the transmitter of the wireless power transfer system. The rectifier further comprises a gate terminal electrically connected to the receive element. The gate terminal is driven by a gate signal in phase with an input signal received at the receive element.

The gate signal controls operation of the current between the source and drain thus controlling rectification of the input signal received at the receive element. As the gate signal is in phase with the input signal, the FET operates as a class E rectifier. A class E rectifier generally operates at high efficiency resulting in a high efficiency rectifier. A diode may be still be used in such a rectifier, but it may be used to reduce losses in the FET, i.e., the FET may include a body diode. However, body diodes may still be lossy and may cause the FET to get hot. The body diode may be replaced with an external diode to bypass this issue. The particulars of the disclosed rectifier will now be described.

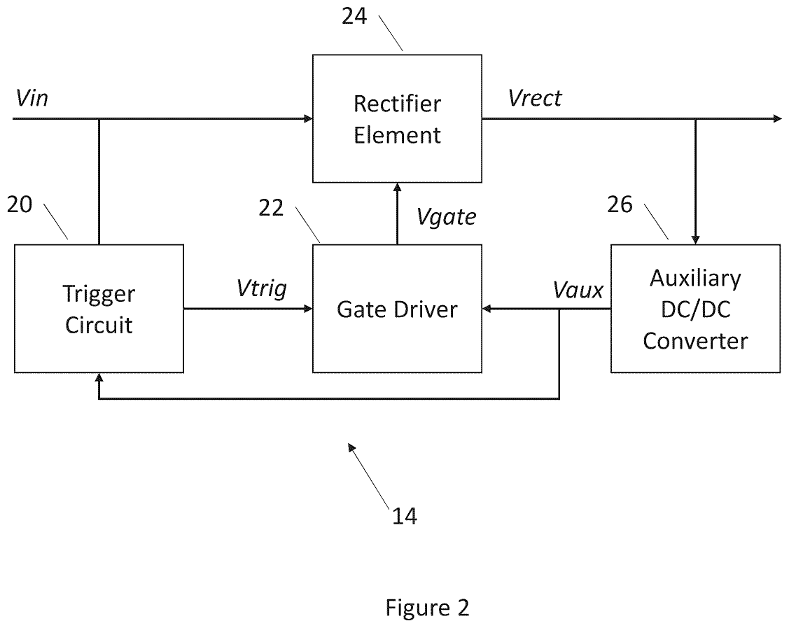

Turning now to FIG. 2, a block diagram of the rectifier 14 is shown. The rectifier 14 is for use in a wireless power transfer system. In particular, the rectifier 14 is suitable for use in a receiver of a wireless power transfer system. The rectifier 14 is a synchronous rectifier as will be described.

The rectifier 14 comprises a rectifier element 24, an auxiliary DC/DC converter 26, a trigger circuit 20 and a gate driver 22. The rectifier element 24 is for rectifying the input RF power to DC. The rectifier element 24 is electrically connected to the trigger circuit 20 and the auxiliary DC/DC converter 26. The rectifier element 24 comprises at least one FET. The FET of the rectifier element 24 is electrically connected at a gate terminal to the gate driver 22 such that the rectifier element 24 is controlled by the gate driver 22 as will be described.

In this embodiment, the rectifier element 24 comprises a load-independent class E rectifier. In general, a class E rectifier may work for a variety of loads. In other words, the rectifier element 24 may be load independent. During operation as the output load varies from the desired load, the rectifier DC voltage varies substantially. Furthermore, when the output load varies from the desired load, the zero-voltage-switching (ZVS) operation of switches of the rectifier becomes compromised and, consequently, the efficiency of the rectifier may decrease. In contrast, a load-independent class E rectifier retains the ZVS operation of switches of the rectifier from a no load condition, i.e. zero load, to a full load condition. In addition, the rectified voltage is relatively constant between the no load and full load conditions. The switching losses from the no load condition to the full load condition are approximately constant and switching efficiency is generally not affected.

The class E rectifier design is adapted for converting the input RF power to DC. The operating or switching frequencies of the rectifier element 24 may be, for example, 1.84 MHz and 3.2768 MHz. The person skilled in the art will appreciate these are only exemplary and other frequencies may be used. The rectified voltage or signal output by the rectifier element 24 is V_{rect}. The RF power input into the rectifier element 24 is Vᵢₙ. The rectified DC voltage, V_{rect}, is unregulated. As the rectifier element 24 comprises a load-independent rectifier, the switch-node waveform does not vary significantly with load as previously described. Thus, the rectified voltage is relatively stable.

The auxiliary DC/DC converter 26 is electrically connected to the gate driver 22, trigger circuit 20 and rectifier element 24. The converter 26 is for converting the V_{rect} output by the rectifier element 24 to an auxiliary voltage range, e.g. in the range of 5V, Vₐᵤₓ, to power the trigger circuit 20 and gate driver 22. The auxiliary power voltage or signal Vₐᵤₓ powers the trigger circuit 20 and gate driver 22. Until the auxiliary DC/DC converter 26 can regulate, the FET of the rectifier element 24 is off and the rectifier element 24 acts as a passive (diode) rectifier. In this embodiment, the auxiliary DC/DC converter 26 comprises a low-power buck converter.

The trigger circuit 20 is electrically connected to the gate driver 22, the auxiliary DC/DC converter 26 and the rectifier element 24. The trigger circuit 20 is powered by a signal, e.g. Vₐᵤₓ, from the auxiliary DC/DC converter 26. The trigger circuit 20 samples the RF power input Vᵢₙ received by the rectifier element 24 and produced an appropriately timed trigger voltage V_{trig}. The trigger voltage or signal V_{trig} is timed such that a gate drive voltage or gate signal V_{gate} output by the gate driver 22 is in phase with the input Vᵢₙ. The trigger circuit 20 is for ensuring proper timing of the gate drive voltage or gate signal V_{gate} output by the gate driver 22. As will be described, the trigger circuit 20 is configured to provide a trigger signal V_{trig} that recovers timing using the input signal Vᵢₙ. In the illustrated arrangement, the trigger signal V_{trig} comprises a pulse signal.

Ideally the rectifier element 24 is open when the incoming current is positive and closed when the incoming current is negative, resulting in proper rectification. Assuming perfect tuning, V_{gate} should be in-phase with Vᵢₙ.

The gate driver 22 is electrically connected to the rectifier element 24, the auxiliary DC/DC converter 26 and the trigger circuit 20. The gate driver 22 is powered by a signal (e.g. Vₐᵤₓ) from the auxiliary DC/DC converter 26. The gate driver 22 outputs a signal to switch the FET of the rectifier element 24. In particular, the gate driver 22 outputs a gate drive voltage or gate signal, V_{gate}, to control operation of the rectifier element 24, e.g. control switching of the FET of the rectifier element 24.

In this embodiment, the gate drive voltage V_{gate} is a delayed and more powerful reproduction of the trigger voltage V_{trig} input into the gate driver 22.

The gate driver 22 and the trigger circuit 20 exhibit non-negligible propagation delays at lower frequencies, e.g., the previously-mentioned exemplary operating frequencies. To address the challenge of the non-negligible propagation delays from the gate driver 22 and the trigger circuit 20, the trigger circuit 20 is designed such that the trigger circuit 20 further delays the output signal V_{trig} to ensure V_{gate} is synchronized with Vᵢₙ.

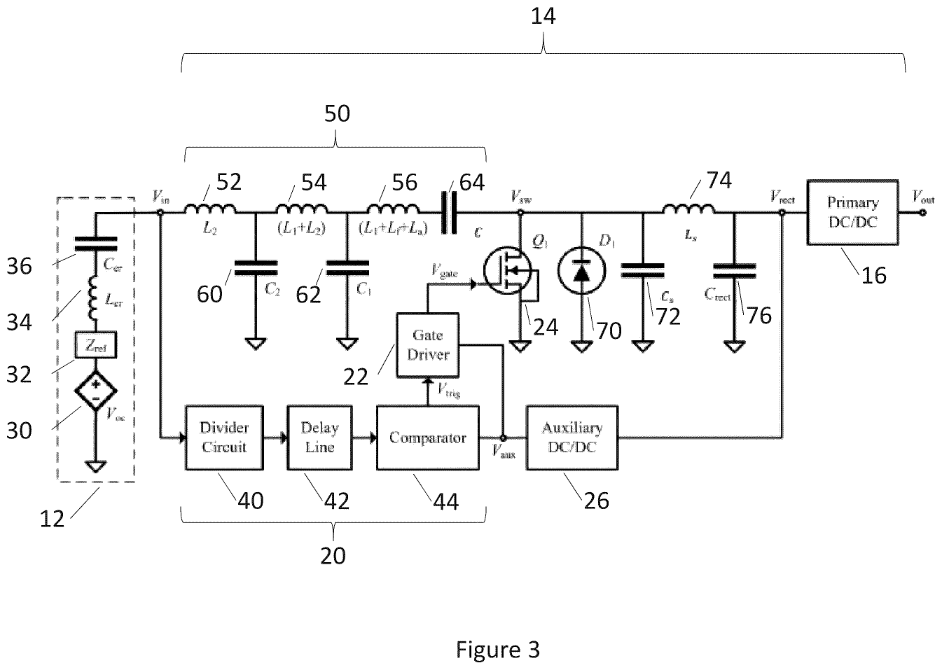

The rectifier 14 has been described in isolation. However, the rectifier 14 is for use in a receiver of a wireless power transfer system. An exemplary receiver is shown in FIG. 3 including the rectifier 14.

As shown in FIG. 3, the receiver comprises a receive element 12, the rectifier 14, a primary DC/DC converter, and a load. The load is not illustrated in FIG. 3. However, the load would be connected to the primary DC/DC converter 16.

The receive element 12 is electrically connected to the rectifier 14. The receive element 12 is configured to receive power from a transmitter using resonant or non-resonant electric or magnetic field coupling. The receive element 12 may extract power from a transmitter via non-resonant or resonant magnetic or electric field coupling. As such, the receive element 12 comprises one or more receive coils (i.e. inductors) or one or more capacitive electrodes. The corresponding transmitter comprises corresponding transmit coils (i.e. inductors) or capacitive electrodes, respectively.

The receive element 12 extracts power from the transmitter and as such outputs an input voltage or signal Vᵢₙ which corresponds to the extracted power or signal.

The receive element 12 has been modelled using a Thevenin equivalent circuit. As shown in FIG. 3, the circuit comprises a voltage source 30, a series impedance 32 having an impedance Zref which is small and resistive at the operating frequency of the receiver, an inductor 34 having an inductance Lr, and a capacitor 36 having a capacitance Cr. This model is based on both the transmit element (of a transmitter which transfers power the receiver) and receive element 12 being well-tuned, exhibiting high unloaded quality factors and being well-coupled. In other words, the power transfer efficiency across the wireless gap (the space between the transmit element and the receive element 12, across which power is transferred from the transmit element to the receive element 12) is high (>90%). As a result, the input voltage Vᵢₙ is a clean sinusoid which is relatively constant as the load changes. Thus, the input voltage is relatively load-independent.

The series impedance 32, inductor 34, and capacitor 36 may form tuning elements which ensure resonance at the switching frequency of the receive element 12 and a corresponding transmit element of a transmitter of a wireless power transfer system. As one of skill in the art will appreciate, one or more of the impedance 32, inductor 34 and capacitor 36 may be omitted.

The rectifier 14 comprises the rectifier element 24, the auxiliary DC/DC converter 26, the trigger circuit 20 and the gate driver 22. In the illustrated arrangement, the rectifier 14 additionally comprises an input stage 50.

The input stage 50 is electrically connected to the rectifier element 24, receive element 12 and trigger circuit 20. The input stage 50 is adapted to perform any combination of three functions. In particular, the input stage 50 is for converting the impedance presented by the rectifier element 24 under nominal loading to the optimal load impedance for the receive element 12. The input stage 50 is for reducing harmonic content generated by the nonlinear action of the rectifier element 24 such that the receiver, and by extension, the wireless power system that the receiver forms a part of, may meet international product requirements relating to electromagnetic compatibility (EMC). The input stage 50 is for ensuring that voltage input into the rectifier element 24 is approximately sinusoidal. The current may also be approximately sinusoidal.

In this embodiment, the input stage 50 comprises a low pass implementation of a double impedance inverter circuit. The input stage 50 further comprises additional filtering added in series with the rectifier element 24. The use of the double impedance inverter topology may beneficially ensure the rectifier element 24 is driven by a quasi-constant voltage source. Further details of the input stage 50 are described below.

The rectifier element 24 is electrically connected to the input stage 50, the gate driver 22, the primary DC/DC converter 16 and the auxiliary DC/DC converter 26. As shown in FIG. 3, the rectifier element 24 comprises a FET. In this arrangement, the FET is an N-Channel MOSFET. The gate driver 22 is electrically connected to a gate terminal of the FET. The input stage 50 is electrically connected to the drain terminal of the FET, as is the primary DC/DC converter 16. The source terminal of the FET is electrically connected to ground.

The primary DC/DC converter 16 is electrically connected to the rectifier element 24, auxiliary DC/DC converter 26 and load (not shown). The primary DC/DC converter 16 is for receiving the DC power signal output from the rectifier element 24, V_{rect}. The primary DC/DC converter 16 interfaces the rectifier element 24 to the load. The primary DC/DC converter 16 is for converting the received DC power signal. The converted DC power signal is output from the primary DC/DC converter 16 to the load.

The auxiliary DC/DC converter 26 is additionally electrically connected to the primary DC/DC converter 16. The auxiliary DC/DC converter 26 is for powering the gate driver 22 and trigger circuit 20.

The gate driver 22 has been previously described.

The load is electrically connected to the primary DC/DC converter 16. The load receives the signal output by the primary DC/DC converter 16, Vout. The load may be variable. As one of skill in the art will appreciate, the load may be directly connected to the rectifier element 24 and received V_{rect} if DC conversion is not required.

The trigger circuit 20 is electrically connected to the receive element 12 and the input stage 50. To address the challenge of the non-negligible propagation delays from the gate driver 22 and the trigger circuit 20, the trigger circuit 20 is designed such that the trigger circuit 20 further delays the output signal V_{trig} to ensure V_{gate} is synchronized with Vᵢₙ.

Only a single-ended half-circuit is shown for convenience. The other half circuit is assumed to be identical, but with a 180° phase shift on the open-circuit voltage, implying perfect balance.

The input stage 50 is electrically connected to the receive element 12 and the rectifier element 24. The input stage 50 receives an input voltage (Vᵢₙ) from the receive element 12. As previously stated, the input stage 50 comprises a double impedance inverter circuit. The double impedance inverter circuit is configured to adapt the impedance, reduce harmonics and ensure the current is sinusoidal. The phase of the input voltage (Vᵢₙ) is fixed and may be relied upon by the rectifier element 12. In the illustrated arrangement, the double impedance inverter circuit comprises inductors 52, 54, 56 and capacitors 60, 62, 64. The inductance of inductor 52 is given by L₂, the inductance of inductor 54 is given by inductance L₁+L₂, and the inductance of inductor 56 is given by L₁+L₁+Lₐ. The capacitance of capacitor 60 is given by capacitance C₂, the capacitance of capacitor 62 is given by capacitance C₁, and the capacitance of capacitor 64 is given by capacitance C_{f}. Circuit parameters L₁, C₁, L₂ and C₂ are associated with double impedance inversion.

The rectifier element 24, specifically the drain terminal of the FET, is electrically connected to a diode (D₁) 70, a capacitor 72 and a shunt capacitor 76 all connected in parallel to the input stage 50. An inductor 74 is connected in series between capacitor 72 and shunt capacitor 76. The capacitance of the capacitor 72 is given by capacitance C_{S}, and the capacitance of the shunt capacitor 76 is given by capacitance C_{rect}. The inductance of the inductor 74 is given by inductance L_{S}. Filtering of the rectified output voltage is achieved using a shunt capacitor 76 with a capacitance of C_{rect}. Additional filtering may be required to meet EMC requirements.

As shown in FIG. 3, the input voltage or signal Vᵢₙ is sampled via a sampling circuit which comprises a divider circuit 40 and fed to a delay line 42. While not shown, the delay line 42 may comprise a lumped element delay line circuit. The output of the delay line 44 is fed to a comparator circuit 44. The comparator circuit 44 is for generating a clock signal by comparing the delayed signal (V_{d}) output by the delay line 44 to a DC level, i.e., ground.

The resulting trigger voltage (V_{trig}) is fed to the gate driver 22. The gate driver 22 converts the trigger voltage to a suitable waveform (V_{gate}) for driving the FET of the rectifier element 24. Both the comparator circuit 44 and the gate driver 22 have propagation delays on the order of nanoseconds, which can be significant when dealing with switching periods of roughly 73.7 ns (for an operating frequency of 13.56 MHZ) or 36.9 ns (for an operating frequency 27.12 MHz). The divider circuit 40, delay line 42 and comparator 44 form the trigger circuit 20. These elements are designed to ensure that V_{gate} is synchronized with Vᵢₙ.

As mentioned, the gate driver 22 and the trigger circuit 20 exhibit non-negligible propagation delays. To address these delays, the delay line 42 further delays the output signal V_{trig} to ensure V_{gate} is synchronized with Vᵢₙ.

The described rectifier 24 may represent a challenging circuit to pursue for mass production due to the complex timing circuits required for synchronizing the rectifier element 24 to the gate driver 22. The delay line 42 itself, for example, is sensitive to low tolerances that affects the timing and stability of the switching, requiring the use of a multi-stage delay line circuit as explained above. This creates a complex control circuit and is not viable for mass production.

Testing several rectifiers, it was found that a delayed time value which is under 5% of half the operating period is typically required for the rectifier element 24 to be stable. Timing mismatches in the rectifier element 24 will cause instability. For a wireless power transfer system having an operating frequency of 13.56 MHZ, for example, the recommended delayed time value is 1.9 ns. However, during testing, the total delay adds up to 7.5 ns, which is over the 5% threshold, requiring a delay line 42 to be installed. As mentioned, inclusion of a delay line 42 may be problematic.

Further, removing the delay line may not only reduce production time and costs, the overall form factor of the rectifier 14 may be reduced.

Additionally, it may be possible to remove the double impedance inverter operating as the input stage 50. Sufficient EMI performance may be achieved with alternative filters such as a series LC or a tank circuit. Significant thermal and moderate efficiency improvements can be expected by making this change. Additionally, filters may be added following the divider circuit 40 to ensure a clean sine wave is presented to the comparator 44. Negligible impact on efficiency can be expected as the magnitude of the signal and the load seen at these additionally filters is very low

The resulting waveform presented to the comparator will be in phase with the input signal, with no distortion making the logic circuit more robust. This is tested in the next section.

Additionally, the described rectifier 14 comprises two comparators 44, one for each single-ended half-circuit shown in FIG. 3. Each comparator 44 compares a delayed input signal Vᵢₙ to a DC level, i.e., ground. In order to ensure the trigger signal V_{trig} is correctly timed, not only is fast switching required at the comparator 44, but synchronisation between both half-circuits of the rectifier 14. This has the potential to introduce delay in the gate signal V_{gate} controlling the rectifier element 24 which can negatively affect system performance. Additionally, the use of the two comparators 44 results in a larger system which is more costly and time intensive to manufacture.

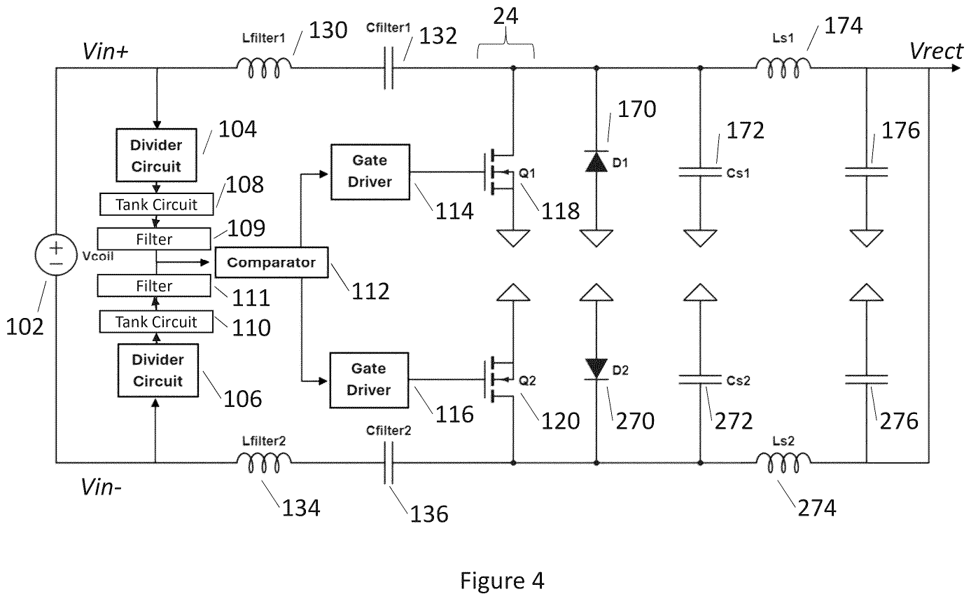

Turning now to FIG. 4, an exemplary arrangement of a receiver (excluding the primary DC/DC converter 16 and load 18) according to an aspect of the disclosure is illustrated. The receiver comprises a voltage source 102 representing the previously described receive element 12. While other elements of the Thevenin equivalent circuit (e.g., the impedance 32, inductor 34, and capacitor 36) are not shown, they may be present. The positive output terminal of the voltage source 102 is electrically connected to a first sampling circuit which in this arrangement takes the form of a first divider circuit 104. The negative output terminal of the voltage source 102 is electrically connected to a second sampling circuit which in this arrangement takes the form of a second divider circuit 106.

The positive and negative output terminals are also electrically connected to filters, specifically series LC filters. However, one of skill in the art will appreciate these may be omitted. Specifically, the positive output terminal is electrically connected to first filter inductor 130 electrically connected in series to first filter capacitor 132. The negative output terminal is electrically connected to second filter inductor 134 electrically connected in series to second filter capacitor 136. The filters may improve thermal performance and/or power transfer efficiency when compared with the previously described double impedance inverter. The filters may isolate the rectifier element switch node from the output terminal node. This may ensure the filtered input voltage Vᵢₙ is generally sinusoidal. This may reduce switching loss at the rectifier element which may improve thermal performance and/or power transfer efficiency.

The divider circuits 104, 106 may each be electrically connected to a filter. In the illustrated arrangement, each filter comprise a tank circuit 108, 110 and high pass filter 109, 111. The filters ensure that a clean sine wave is presented a differential comparator 112 which is electrically connected to each filter, e.g., tank circuit 108, 110 and high pass filter 109, 111. Negligible impact on efficiency can be expected since the magnitude of the signal and the load seen at these filters is very low at this node. Utilising tank circuits 108, 110 does not introduce any phase shift so as to not affect the timing of the rectifier. The waveform presented by each tank circuit 108, 110 and filter 109, 111 to the comparator 112 will be in phase with the input signal (Vin+, Vin−), with no distortion making the rectifier. The high pass filter 109, 111 may shift a signal, e.g., the sampled input signal to the appropriate range. This may combat propagation delays specifically at higher frequencies.

One of skill in the art will appreciate that the high pass filter 109, 111 may be omitted. Furthermore, other variations of filters, e.g., low pass, band pass, etc., filters may be implemented alongside the tank circuit 108, 111.

The dividers circuits 104, 106 are electrically connected to the differential comparator 112 via the tank circuits 108, 110. The differential comparator 112 compares the positive input signal Vin+ from the receive element with the negative input signal Vin− from the receive element. The comparison yields the output of the differential comparator 112, a trigger signal, e.g., V_{trig}. The trigger signal is used to operate gate drivers 114, 116 which are electrically connected to the differential comparator 112.

The gate drivers 114, 116 are electrically connected to the rectifier element 24 which in this arrangement takes the form of FETs 118, 120. Specifically, gate driver 114 is electrically connected to FET 118, and gate driver 116 is electrically connected to FET 120. The gate drivers 114, 116 are electrically connected to the gate terminals of the respective FETs 118, 120. The gate drivers 114, 116 output a gate signal, e.g., V_{gate}, which controls operation of the FETs 118, 120. The source terminals of the FETs 118, 120 are electrically connected to ground. The drain terminals of the FETs 118, 120 are electrically connected to the filters, i.e., capacitors 132, 136, respectively.

The FETs 118, 120 are controlled by the gate drivers 114, 116 to output the rectified voltage Vrect. Use of a differential comparator 112 to compare the positive and negative signals at the receive element of the receiver provides accurate control of the gate drivers 114, 116 and therefore accurate switching by the FETs 118, 120. As such, timing of the rectifier illustrated in the FIG. 4 may be improved. For example, as the positive and negative signals form the basis of the comparison at the differential comparator 112, common noise at the signals may be cancelled improving operation of the rectifier.

Additionally, the duty cycle and/or frequency of the differential comparator 112 may be approximately 50% as the positive and negative outputs of the same receive element are being compared.

Further, the use of the filters, i.e., LC filters comprising inductors 130, 134 and capacitors 132, 136, may allow for the comparator to still have some propagation delay and not require the same switching speeds as required for the comparator 44 illustrated in FIG. 3. This may reduce production times and costs.

The drain terminals of the FETs 118, 120 are electrically connected to a number of other electrical components.

The drain terminal of the FET 118 is electrically connected to a diode 170 (D1), a capacitor 172 and a shunt capacitor 176 all connected in parallel. An inductor 174 is connected in series between capacitor 172 and shunt capacitor 176. The capacitance of the capacitor 172 is given by capacitance Cs1. The inductance of the inductor 174 is given by inductance Ls1. The drain terminal of the FET 120 is electrically connected to a diode 270 (D1), a capacitor 272 and a shunt capacitor 276 all connected in parallel. An inductor 274 is connected in series between capacitor 272 and shunt capacitor 276. The capacitance of the capacitor 272 is given by capacitance Cs2. The inductance of the inductor 274 is given by inductance Ls2.

While detailed electrical schematics of the divider circuits 104, 106; tank circuit 108, 110; and high pass filter 109, 111, are not provided, these are readily apparent to the person skilled in the art.

For example, divider circuit 104, 106 may each comprise a voltage divider. Further, the divider circuits 104, 106 may each comprise a capacitive voltage divider comprising a first capacitor electrically connected in series to an inductor for cancelling capacitive reactance. The capacitive voltage divider may further comprise a second capacitor electrically connected at one end between the first capacitor and the inductor. The other end of the second capacitor is grounded.

Additionally, the tank circuits 108, 110 may each comprise an inductor and capacitor electrically connected in parallel.

While an auxiliary DC/DC converter is not illustrated in FIG. 4, one of skill in the art will appreciate that such a converter may be present. For example, the auxiliary DC/DC converter 26 may be present. The converter 26 may power the differential comparator 112, and gate drivers 114, 116.

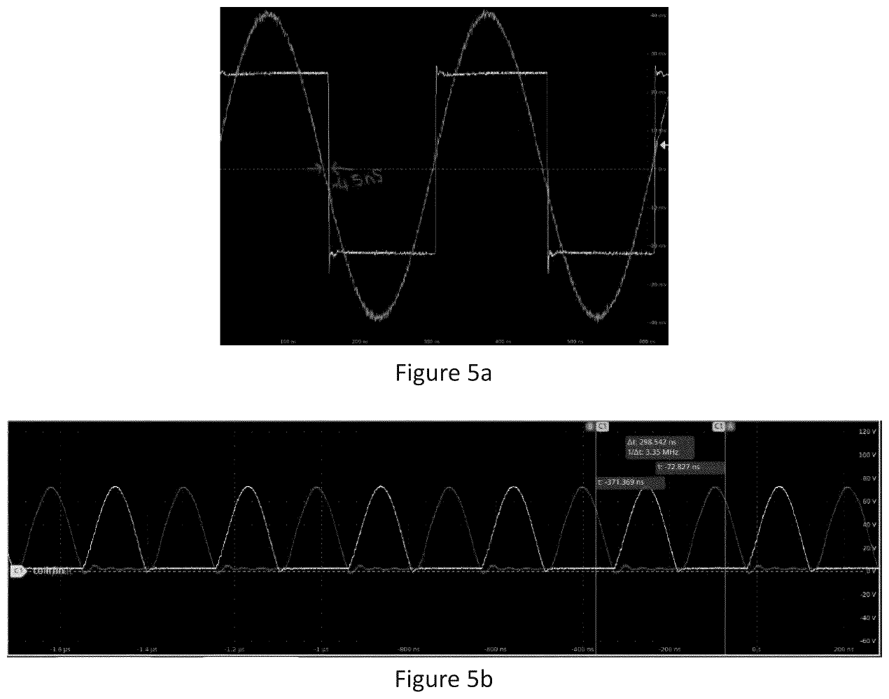

Experimental designs for the receiver illustrated in FIG. 4 were built and tests were conducted on these experimental designs as part of a complete wireless power transfer system comprising the receiver. FIGS. 5a to 9 are a series of graphs illustrating the performance of such an experimental system.

Initially a feasibility test was initially completed to determine whether the rectifier is stable at an operating frequency of 3.2768 MHz without the described delay line 42 no delay line. A TI model number TLV3501 comparator was used as the differential comparator 112 along with TI model number LMG1020 gate driver as the gate driver 114, 116. EPC eGaN switch having the model number EPC2207 were used as the FETs 118, 120. The delay between the input sine wave from the receive element and the square wave output by the differential comparator 112 are illustrated in FIG. 5a. As shown in FIG. 5a, a delay of 4.5 ns is present.

The resulting switching voltage of the FETs 118, 120 is illustrated in FIG. 5b. This voltage is present when the separation distance between the receiver and the transmitter are approximately 35 mm and the load is 15 W.

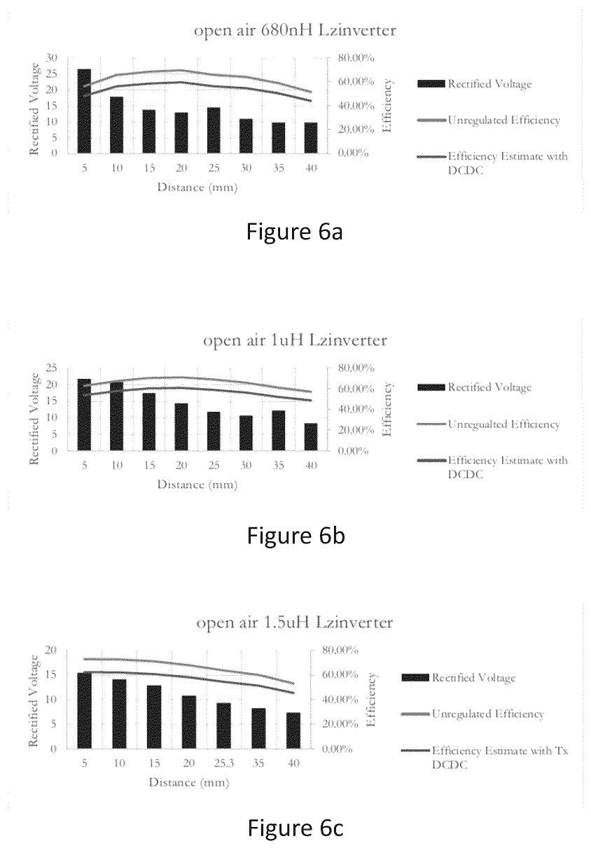

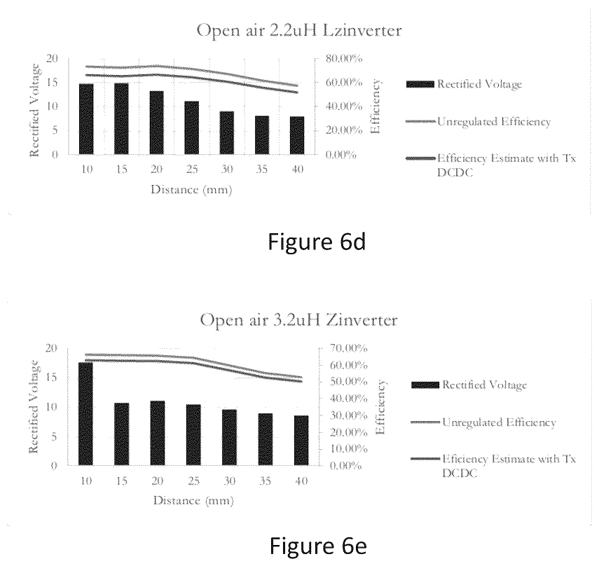

Further tests were conducted with several designs of the receiver illustrated in FIG. 4. In particular, various transmitters were used to transfer electrical power to the receiver. As shown in FIGS. 6a-6e, transmitters comprising a variety of inverters were used in wireless power transfer to the receiver of FIG. 4. In all instances power was transferred from the transmitter to the receiver with open air between the two, i.e., no physical media between the transmitter and transmitter. In particular, FIG. 6a illustrates the power transfer efficiency and rectified voltage V_{rect} output by the rectifier of the receiver when the transmitter has a Z-source inverter (ZSI) having an impedance of 680 nH. In FIGS. 6b-6e, the impedance is 1 uH, 1.5 uH, 2.2 uH, and 3.2 uH, respectively. The rectified voltage and power transfer efficiency is shown for a separation distance (distance between the transmitter and receiver) ranging from 0 mm to 50 mm. FIGS. 6a-6e also illustrate the power transfer efficiency between the transmitter and receiver of the wireless power transfer system with no DC/DC converter at the transmitter (“Unregulated Efficiency”), and the power transfer efficiency with a DC/DC converter at the receiver (“Efficiency Estimate with Tx DCDC”).

While FIGS. 6a-6a illustrated rectified voltage and power transfer efficiency with an open-air media, specific media may be placed between the transmitter and receiver of a wireless power transfer system. For example, the media may include glass, wood, concrete, foam, insulation, etc. As shown in Table 1 below, rectified voltage and power transfer efficiency were determined when the media between the transmitter and receiver was glass. In this instance, the receiver used was the receiver illustrated in FIG. 4. Rectified voltage was determined in a no load condition (load=0 W), and when the load was 15 W. Additionally, power transfer efficiency was determined without a DC/DC converter at the receiver, and with a DC/DC converter electrically connected between the rectifier and load of the receiver. The results are presents in Table 1 below for the receiver illustrated in FIG. 4 which is referred to as “Class-E Synchronous Rectifier”.

TABLE 1
Class-E Synchronous Rectifier Results

| | Vᵢₙ | | | | | | Power |
|---|---|---|---|---|---|---|---|
| | (minimum | | | | | | Transfer |
| Separation | working | | | | Power | | Efficiency |
| Distance | voltage) | V_{rect} | Iᵢₙ | Load | Transfer | ΔV_{rect} | with DC/DC |
| (mm) | (V) | (V) | (A) | (W) | Efficiency | (V) | Converter |
| 17 | 16 | 14.09 | 0.206 | 0 | — | 3.43 | — |
| | 16 | 10.66 | 1.425 | 15 | 65.79% | — | 62.50% |
| 20 | 18 | 13.50 | 0.500 | 0 | — | 2.44 | — |
| | 18 | 11.06 | 1.271 | 15 | 65.57% | — | 62.29% |
| 25 | 22 | 12.33w | 0.216 | 0 | — | 1.92 | — |
| | 22 | 10.41 | 1.060 | 15 | 64.32% | — | 61.11% |
| 30 | 26 | 11.39 | 0.239 | 0 | — | 1.85 | — |
| | 26 | 9.54 | 0.965 | 15 | 59.78% | — | 56.80% |
| 35 | 30 | 10.76 | 0.268 | 0 | — | 1.85 | — |
| | 30 | 8.91 | 0.906 | 15 | 55.19% | — | 52.43% |
| 40 | 32 | 10.45 | 0.278 | 0 | — | 1.92 | — |
| | 32 | 8.53 | 0.888 | 15 | 52.79% | — | 50.15% |

Vin is the input voltage from the receive element 12 and Iᵢₙ is the input current from the receive element 12. ΔV_{rect} is the difference in rectified voltage between no load and full load (15 W) conditions.

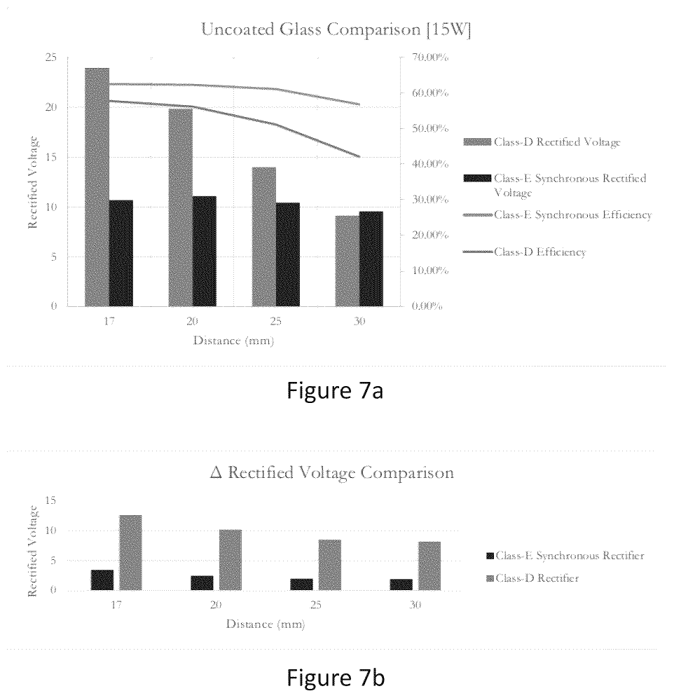

While Table 1 illustrated the rectified voltage and power transfer efficiency for the receiver illustrated in FIG. 4, this approach to rectification may be compared with a known Class-D rectifier. A class-D rectifier may comprise a diode electrically connected in parallel to a first capacitor with a further capacitor electrically connected in series between the first capacitor and diode. The rectified voltage and power transfer efficiency for a receiver utilising a Class-D rectifier and the receiver illustrated in FIG. 4 are presented in FIG. 7a. Both receivers included a 12 V DC/DC converter at the output of the rectifier, i.e., electrically connected between the rectifier and the load of the receiver. The load in both receivers was 15 W. The media between the transmitter and receiver was uncoated glass. The separation distance was varied from 17 mm, 20 mm, 25 mm, to 30 mm. No double impedance inverter was installed on the Class-E and Class-D setup. However, the Class-E synchronous rectifier does include the series LC filter, which will provide some filtering in comparison to the Class-D.

As illustrated in FIG. 7a, the receiver of FIG. 4 (“Class-E rectifier”) maintains a higher efficiency throughout the test, even with the added LC filters. In particular, the power transfer efficiency is over 60% through all separation distance for the Class-E rectifier. In comparison, the power transfer efficiency of the Class-D rectifier is below 60% at all separation distances.

FIG. 7b illustrates a comparison of the voltage difference under no load and full load (15 W) between the Class-E and Class-D rectifiers. An insignificant delta is noticed with the Class-E. This may make it more possible to work under very low voltages and at wider transmission distance.

While performance is presented for a media comprising uncoated glass, coated glass may also form the media between transmitter and receiver. Coated glass may comprise glass coated with a variety of coatings. The coatings may comprise metal oxides forming a thin layer over the glass (i.e., 0.01 um to 0.8 um). The coated glass may comprise low-emissivity (low-e) coated glass.

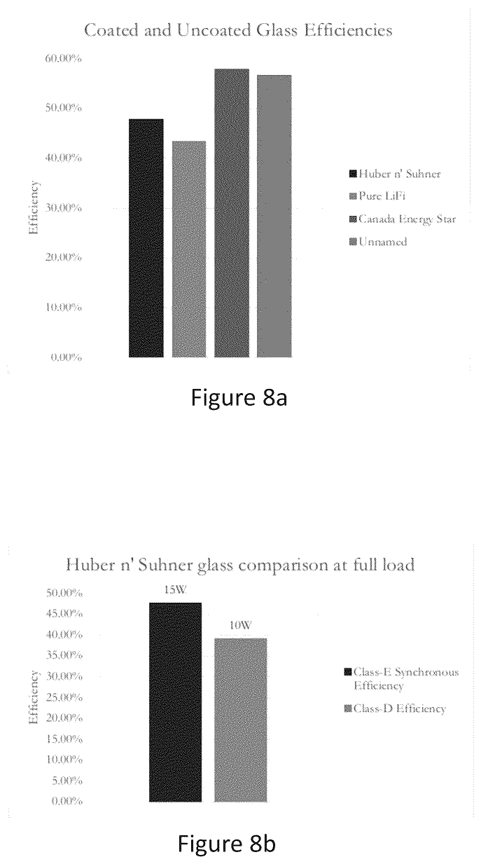

Power transfer efficiency is presented for the Class-E rectifier (the receiver illustrated in FIG. 4) for a variety of coated glass in FIG. 8a. In particular, the coated glass comprises: glass manufactured by Huber+Suhner™, Canadian ENERGY STAR certified glass coated glass, and an unnamed coated glass. As shown in FIG. 8a, power transfer efficiency is over 40% for all coated glass types.

This performance is compared with the Class-D rectifier previously discussed for the Huber+Suhner™ coated glass. The results of this comparison at full load (15 W) are illustrated in FIG. 8b. The Class-D rectifier tripped when the load exceeded 10 W whereas the Class-E rectifier was able to handle the full load and provided a higher power transfer efficiency.

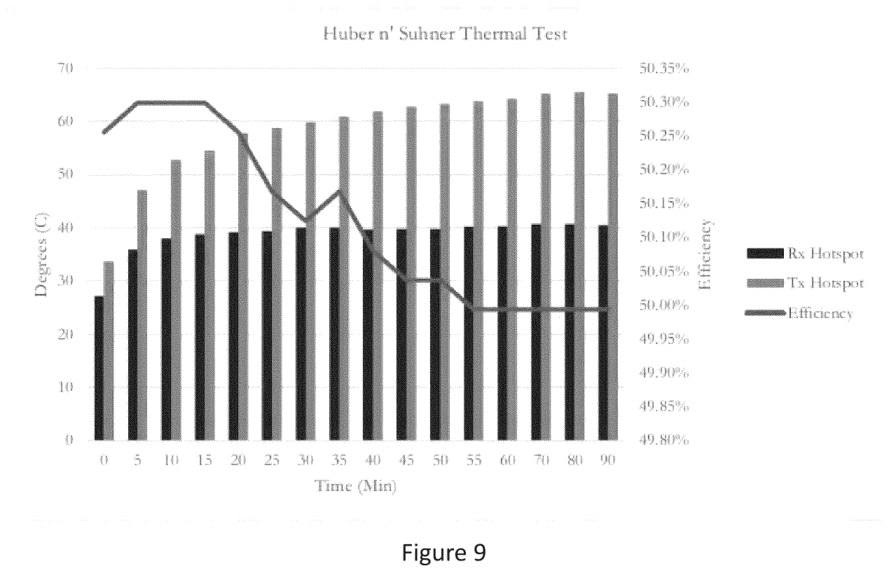

A thermal test was also conducted with the Huber+Suhner™ coated glass at ambient temperature with Class-E rectifier (receiver illustrated in FIG. 4). The highest temperatures at the receiver and transmitter were recorded as well as the power transfer efficiency over a period of time. The results of the thermal test are illustrated in FIG. 9. In particular, FIG. 9 is a graph of power transfer efficiency and thermal performance over time. As shown in FIG. 9, power transfer efficiency generally decreases over time, but stabilises at around 50% after 50 minutes. Further, temperature at the receiver stabilises at around 40 degrees Celsius after 30 minutes. Transmitter temperature rises slowly stabilising after about 70 minutes. In FIG. 9, a full load is 15 W. Further, the separation distance is 25 mm.

While performance has been illustrated for certain coated class, Class-E rectifier (the receiver illustrated in FIG. 4) may transfer power efficiently at a variety of loads through a variety of glass. For example, the system was tested for various media set out in Table 2 below. In particular, the number of panes are varied for the glass, i.e., single pane, double pane, and triple pane; the thickness of the glass is varied; the number coatings is varied, i.e., no coating, a single coating, and two coatings; and the type of coating is varied, i.e., hard coated, a first silver coating type (AG1), or a second silver coating type (AG2). The double pane silver coated glass with two coatings (number 3) is a reflective glass.

TABLE 2
Media Variations

| | | | Number of | Type of |
|---|---|---|---|---|
| Number | Panes | Thickness | Coatings | Coatings |
| 1b | Double | 18.7 | 1 | Hard-Coat |
| 1d | Double | 18.9 | 1 | Hard-Coat |
| 1e | Double | 20.1 | 1 | Hard-Coat |
| 2 | Double | 17.9 | 1 | AG1 |
| 3 | Double | 23.2 | 2 | AG1, AG1 |
| 5 | Double | 27.5 | 1 | AG1 |
| 8 | Triple | 31.3 | 2 | AG1, AG1 |
| 9 | Triple | 31.4 | 1 | Hard-Coat |
| 12 | Triple | 31 | 2 | AG1, AG1 |
| 13 | Triple | 30.8 | 2 | AG1, AG1 |
| 15 | Double | 27.9 | 1 | AG2 |
| 16 | Double | 19.6 | 1 | AG3 |
| 10b | Triple | 33 | 2 | AG2, AG2 |
| 10 mm | Single | 10 mm | 0 | — |
| 15 mm | Single | 15 mm | 0 | — |
| 20 mm | Single | 20 mm | 0 | — |
| 25 mm | Single | 25 mm | 0 | — |
| 30 mm | Single | 30 mm | 0 | — |
| 35 mm | Single | 35 mm | 0 | — |
| 40 mm | Single | 40 mm | 0 | — |

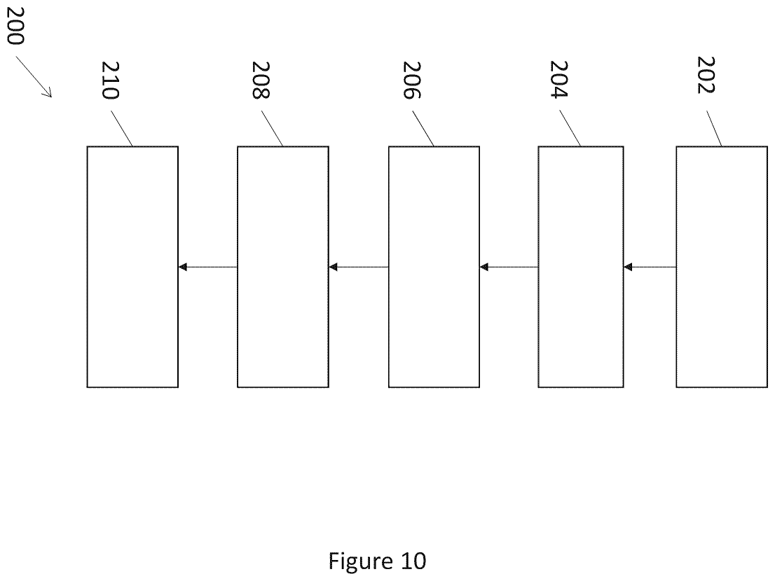

Turning now to FIG. 10, a flowchart of a method 200 of rectifying power received at a receiver of a wireless power transfer system is shown. The receiver may comprise the receiver illustrated in FIG. 4.

The method comprises comparing 206 a positive input signal received at the receive element to a negative input signal received at the receive element to generate a trigger signal. The positive and negative input signals are output by one or more receiver elements of the receiver. The comparing 206 is performed by a differential comparator (e.g., differential comparator 112).

The method 200 further comprises operating 208 the gate drivers 114, 116 via the generated trigger signal to generate a gate signal. The trigger circuit is output by the differential comparator (e.g., differential comparator 112).

The method 200 further comprises driving 210 the rectifier element 24 (e.g., FETs 118, 120) via the generated gate signal. The gate drivers 114, 116 output the gate signals which control operation of the rectifier element 24 (e.g., switching of the FETs 118, 120).

No double impedance inverter stage is required for the described rectification. Further a single differential comparator (e.g., differential comparator 112) is utilised rather than multiple comparators. The differential comparator compares the positive and negative outputs of the receive elements such that the resulting output trigger signal is correctly timed without the need for a delay line.

The method 200 may further comprise sampling 202 the positive and negative input signals. The sampling 202 may be performed by divider circuits 102, 106 which voltage divided the input positive and negative signals.

The method 200 may further comprise filtering 204 the positive and negative input signals. The filtering 204 occurs after the sampling 202. The filtering 204 may be performed by a filter (e.g., tank circuit 108, 110 and high pass filter 109, 111).

Each individual feature described herein is disclosed in isolation and any combination of two or more features is disclosed to the extent that such features or combinations are capable of being carried out based on the specification as a whole in the light of the common general knowledge of one of skill in the art, irrespective of whether such features or combination of features solve any problems disclosed herein, and without limitation to the scope of the claims. Aspects of the disclosure may consist of any such individual feature or combination of features. In view of the foregoing description it will be evident to one of skill in the art that various modifications may be made within the scope of the disclosure.

What is claimed is:

1. A trigger circuit for use in a rectifier of a receiver of a wireless power transfer system, the rectifier for receiving wireless power transferred from a transmitter of the wireless power transfer system, the trigger circuit comprising:
a differential comparator for generating a trigger signal by comparing a positive input signal received at a receive element of the receiver to a negative input signal received at the receive element.

2. The trigger circuit of claim 1, wherein the positive input signal and the negative input signal are approximately 180 degrees out of phase.

3. The trigger circuit of claim 1, wherein the input signals comprise sines waves.

4. The trigger circuit of any claim 1, wherein an output of the differential comparator has a duty cycle of 50%.

5. The trigger circuit of claim 1, further comprising a filter for filtering the input signals

6. The trigger circuit of claim 1, further comprising at least one sampling circuit for sampling the positive or negative input signal, wherein the sampling circuit comprises a divider circuit.

6. The trigger circuit of claim 1, wherein at least one of:
the trigger circuit is electrically connectable to two gate drivers,
the trigger circuit is configured to output the trigger signal to operate a gate driver of a rectifier, the trigger signal comprises a clock signal, the trigger signal comprises a square wave, and the trigger circuit is electrically connectable to a receive element of the receiver.

7. A rectifier for use in a receiver of a wireless power transfer system, the rectifier for receiving wireless power transferred from a transmitter of the wireless power transfer system, the rectifier comprising:
two rectifier elements for rectifying an input AC signal received at a receive element of the receiver to DC;
two gate drivers, each gate driver for controlling operation of one of the two rectifier elements; and
a trigger circuit comprising a differential comparator for generating trigger signals for operating the gate drivers by comparing a positive input signal received at the receive element to a negative input signal received at the receive element.

8. The rectifier of claim 7, wherein the positive input signal and the negative input signal are approximately 180 degrees out of phase.

9. The rectifier of claim 7, wherein the differential comparator has a duty cycle of 50%.

10. The rectifier of claim 7, wherein the trigger circuit comprises one or more filters for filtering the input signal.

11. The rectifier of claim 10, wherein the trigger circuit comprises two sampling circuits, each sampling circuit for sampling a respective one of the positive and negative input signals.

12. The rectifier of claim 11, wherein each filter is electrically connected to each sampling circuit between the sampling circuit and the differential comparator.

13. The rectifier of claim 7, further comprising two filters, each filter electrically connected to one of the two rectifier elements.

14. A receiver for extracting power from a transmitter of a wireless power transfer system, the receiver comprising:
a receive element for receiving wireless power transferred from the transmitter; and
the rectifier of claim 8 for use in the receiver, the rectifier for receiving wireless power transferred from a transmitter of the wireless power transfer system.

15. A wireless power transfer system for transmitting power via magnetic or electric field coupling, the wireless power transfer system comprising:
a transmitter comprising a transmit element for generating a magnetic or electric field;
a receiver for extracting power from the transmitter, the receiver including
a receive element for receiving wireless power transferred from the transmitter; and
the rectifier of claim 8 for use in the receiver, the rectifier for receiving wireless power transferred from a transmitter of the wireless power transfer system.

16. A method of operating a gate driver of a rectifier of a receiver of a wireless power transfer system, the receiver comprising a receive element for extracting power from a generated field, the rectifier comprising one or more gate drivers, the method comprising:
comparing a positive input signal received at the receive element to a negative input signal received at the receive element to generate a trigger signal; and
operating the gate driver via the generated trigger signal.

17. The method of claim 16, further comprising filtering the positive and/or negative input signal.

18. The method of claim 17, wherein at least one of:
the filtering occurs prior to the comparing, and
the filtering comprises, filtering the positive and/or negative input signal via one or more tank circuits and/or high pass filters.

19. The method of claim 16, further comprising sampling the positive and/or negative input signal.

20. The method of claim 16, wherein the operating comprises operating the gate driver via the generated trigger signal to generate a gate signal, and wherein the method further comprises:
driving one or more rectifier elements of the rectifier via the generated gate signal.
